(19) United States
(12) Patent Application Publication
(10) Pub. No.: US 2024/0136172 A1
(43) Pub. Date: Apr. 25, 2024

(54) APPARATUS FOR TRAPPING IONS

(71) Applicant: Thermo Fisher Scientific (Bremen) GmbH, Bremen (DE)

(72) Inventor: Hamish STEWART, Bremen (DE)

(73) Assignee: Thermo Fisher Scientific (Bremen) GmbH, Bremen (DE)

(21) Appl. No.: 18/492,716

(22) Filed: Oct. 22, 2023

(30) Foreign Application Priority Data
Oct. 23, 2022 (GB) 2215732.5

(51) Int. Cl. H01J 49/42

(52) U.S. Cl. CPC H01J 49/4225

(57) ABSTRACT

Apparatuses for trapping ions comprise an array of electrodes extending along a surface and one or more further electrodes that are distinct from the array of electrodes. A trapping region for receiving the ions is defined by the array of electrodes and the one or more further electrodes. A control circuit is configured to apply a set of oscillatory voltages to the array of electrodes to repel the ions, wherein each electrode in the array has a different phase to each adjacent electrode. A trapping voltage is applied to at least one of the one or more further electrodes to force the ions towards the array of electrodes, the set of oscillatory voltages and the trapping voltage thereby trapping the ions within the trapping region, wherein the trapping voltage is a time-varying direct current, DC, voltage that increases in magnitude over time.

### FIELD

The present disclosure concerns apparatus for trapping ions.

### BACKGROUND

Extraction traps are devices coupled to a mass analyser that accumulate and trap ions from an ion source, such as a continuous or pulsed ion source. Extraction traps typically collisionally cool and compress the ions to a packet of favourable spatial and energy properties, and then pulse extract the ions into an analyser. Extraction traps have been paired with many different types of analyser, including magnetic sector (Mather et al., International Journal of Mass Spectrometry and Ion Physics, 1978, 28, 347-364), time-of-flight (Chien et al., Rapid Communications in Mass Spectrometry, 1993, 7, 837-843), quadrupole (Bonner et al., International Journal of Mass Spectrometry and Ion Physics, 1972, 10, 197-203) and Fourier Transform analysers (e.g. orbital trapping mass analysers, such as the Orbitrap™ (U.S. Pat. No. 7,425,699B2)).

Historically, the most common extraction trap has been the 3D quadrupole ion trap, or Paul trap, described in U.S. Pat. No. 2,939,952A and shown coupled to time-of-flight analysers in U.S. Pat. No. 5,569,917A, U.S. Pat. No. 6,803,564B2 and U.S. Pat. No. 6,380,666B1. FIG. 1 shows a modern layout of a quadrupole ion trap serving as the ion source for a reflectron time-of-flight analyser, whereby high voltages applied to either end of the trap eject ions. Ions travel down the length of the analyser, before being reflected back, and focused, to an ion detector by the reflectron, or ion mirror.

The Paul trap suffers from low trapping efficiency, as ions are injected across a high RF field and have little distance to adequately cool and become trapped. The Paul trap also suffers from strong space charge effects, as all ions are focused to a point. Strong space charge effects are problematic both for analytical traps, and for time-of-flight analysers, which rely on very tightly-defined ion packet properties for optimal focusing and high resolution.

3D traps have been largely superseded by linear ion traps, usually an assembly of elongated RF multipole rods capped by terminal DC electrodes, which use an RF pseudopotential to focus ions radially, and axially trap ions via the terminal electrode DCs (Donald J. Douglas et al, Mass Spectrometry Reviews, 2004, 24, 1-29). The advantages of these are higher trapping efficiencies when ions are injected down the longitudinal axis, giving space for collisional cooling, and a typically 30-50x improvement in space charge capacity as the ion packet is allowed to spread along said axis. Space charge capacity may be improved with higher order multipoles trapping fields, such as the hexapole shown by Franzen in U.S. Pat. No. 5,763,878A, although these suffer from having ions spread out along the time-of-flight (ToF) axis, resulting in relatively poor focusing properties upon pulse extraction.

An additional ion guiding/trapping structure exists in the form of the “RF carpet”. In an RF carpet, a closely packed series or array of electrodes, each with a different (e.g. opposite) RF amplitude to its neighbours, forms a pseudopotential barrier across the surface the electrodes are spread over. Ions may be pinned against this pseudopotential surface by a DC electrode mounted opposite the array of electrodes, and ions will spread across the region. They may also be transported across the RF carpet by for example a DC gradient, or a traveling wave superimposed onto the RF electrodes (G. Bollen, Int. J. Mass. Spectrom., 2011, 299, 131-138). The SLIM (Structures for Lossless Ion Manipulations) family of PCB printed RF surface devices also includes DC barrier electrodes and switches implemented in an integrated fashion with the RF electrodes on the same surface (US20190103261A1).

The ideal initial ion packet shape for a time-of-flight analyser is a thin disk, which maximises the volume for space charge without compromising the small ToF axial spatial distribution required for narrow extracted ion time focus and corresponding high instrument resolution. Because ions spread across the length and width of the RF carpet, they form a broadly planar packet, which is particularly suited for ToF applications, with a thickness determined by the strength of the counter DC and the strength of the exponential rise of the RF pseudopotential with proximity to the RF electrodes. This latter factor may be increased by increasing the density of the electrodes in the series, even to lithographic scales, although this also brings ions extremely close to the physical surface with consequential risks of charging and mechanical tolerance.

Whitehouse in U.S. Pat. No. 6,683,301B2 and U.S. Pat. No. 7,365,317B2 describes how an RF carpet, or surface, may be configured to act as an extraction trap. U.S. Pat. No. 8,373,120 shows similar systems. FIG. 2 reproduces the proposed layout of the device of U.S. Pat. No. 6,683,301B2. In this document, ions are injected over an RF carpet formed of a 2D array of electrodes and pinned to the array via an opposing DC from a gridded counter-electrode located above. Ions could then be pulse-extracted through the grid and into a time-of-flight analyser, by high voltages applied to both the grid and the RF surface electrodes.

While FIG. 1 shows a general Trap-Reflectron-ToF instrument layout, also of relevance are multi-reflection time-of-flight analysers, where ions are directed along a tightly folded, highly elongated flight path. Such instruments are typically capable of considerably higher resolution than single-reflection analysers, but often suffer severe space charge issues, as reported by Grinfeld (D. Grinfeld, A. E. Giannakopulos, I. Kopaev, A. Makarov, M. Monastyrskiy, M. Skoblin, Eur. J. Mass Spectrom. 2014, 20, 131-42). A notable analyser example, fed by a linear ion trap, is described by Grinfeld in U.S. Pat. No. 9,136,101B2 and with a complete instrument configuration shown by Hock in U.S. Pat. No. 10,593,525B2. This device extracts ions from a linear ion extraction trap and directs them to oscillate between a pair of elongated ion mirrors. The oscillating ion packet drifts down the length of the mirrors and is allowed to expand, helping to reduce space charge effects. The mirrors are tilted with respect to one another, creating a retarding potential that reflects the ion packet and redirects it back to a detector located adjacent to the extraction trap.

However even with this space charge limiting feature, the raw space charge influence on an ion packet remains substantial, with resolution greatly reduced at ˜1500 ions in a packet. Moreover, when the pseudopotential well depth of the extraction trap is limited, allowing ions to spread out within the trap, the tolerance of resolution to ion number increases substantially. Because the expansion of the ion cloud also interferes with focal properties, the highest point of resolution is substantially compromised. Similarly, the mirror system could be re-tuned to optimize to a level of space charge, but again at the cost of top-level resolution performance. It would be desirable to have either less compromise between space charge and resolution, or a much greater accessible space charge range. FIG. 3 shows how MR-ToF resolution and space charge trends vary with differing linear trap well depths.

An important feature for extraction traps is that they should operate rapidly, processing differing injected ion packets into thermalized clouds and extracting into the analyser at competitive acquisition rates, which at present for time-of-flight instruments is considerably greater than 100 Hz. This requires relatively high gas pressures within the trap, typically >2×10⁻³ mbar to rapidly cool ions injected with ˜7 eV kinetic energy. However, such pressures cause a considerable gas leak into the analyser, a problem exacerbated by the large open area of the extraction grid in an RF carpet trap. A known solution is to rapidly pre-cool the ions in a high-pressure region of the trap adjacent to the extraction region, and then transfer ions across a gas restriction with relatively lower energy, requiring much lower pressure to suitably thermalise. Giles et al in US20190103263A1 described a segmented linear quadrupole trap with two such pressure regions, and an interface segment with smaller radius which would effectively restrict gas movement without acting as a barrier to the transfer of ions.

Trap-ToF instruments suffer greatly from space charge effects when there are many ions of similar m/z. As ion number in a packet grows the resolution rapidly collapses and there is often a significant shift in the average m/z measured.

A further deleterious effect is the overall expansion of the ion cloud when the total number of ions in the trap exceeds the threshold defined by the RF pseudopotential well. When this happens, the poorly trapped higher m/z ions are forced to the outsides of the trapped ion volume and may suffer a substantial resolution drop, mass shift, and sensitivity losses caused by failure of trapping and transmission.

There are a number of ways to increase trap space charge capacity, essentially by increasing the trapping volume. Larger traps, or those with higher order multipoles may trap a vastly greater number of ions than a Paul trap, however if this increase comes with an increase in the ion spatial spread in the ToF flight axis then the extracted ion packet's focal properties will be impaired and instrument resolution compromised.

Particularly important has been the shift from 3D traps to elongated linear ion traps, because this allows expansion of the ion cloud in one dimension orthogonal to the analyser axis, i.e. an expansion in space charge capacity without compromising resolving power. The next step, of allowing ions to expand in both orthogonal dimensions, is achieved via an RF surface as described by Whitehouse in U.S. Pat. No. 6,683,301B2 and U.S. Pat. No. 7,365,317B2.

A disadvantage of such RF surfaces is that because the trapped ion plane is located at the point in which the pseudopotential is strong enough to balance the counterforce from the DC, ions of different m/z find themselves located at differing distances from the RF surface. For a time-of-flight analyser this is problematic, as pseudopotential strength is mass-dependent and thus induces a mass dependency in the position of the time focus (i.e. a m/z shift), which can cause issues, a problem which is not addressed or recognised in the art. An additional problem is that large planar surfaces require a large extraction grid, which from a gas filled trap necessitates a far greater leakage of gas into the analyser than occurs with linear or 3D traps.

One known technique for expanding the ion cloud within an extraction source is “delayed extraction.” Originally, this related to laser-based techniques such as MALDI ion sources, where benefits to a delay between the laser pulse and the application of the extraction field were found. These included reduction of the of non-ionised material in the MALDI plume that might otherwise collide with energetic analyte ions and generate fragmentation, creating a relationship in the ion source between ion energy and spatial position that could be focused by the extraction field for high resolution, and the expansion of the ion cloud would also reduce space charge influence. For RF traps, delayed extraction typically means a delay between the quenching of RF and the application of the extraction field, for example to manipulate ion phase space as in U.S. Pat. No. 9,595,432B2, or to allow time for RF to be more fully quenched.

Solutions within the analyser itself have also been proposed. The MR-ToF analyser of U.S. Pat. No. 9,136,101B2 is specifically designed to allow the ion cloud to expand out and limit space charge effects, though in practice it still suffers greatly from them, and such a design becomes more vulnerable to mechanical error than analysers with a tightly focused beam. Lenses may be used to expand the extracted ion beam, though this occurs sometime after extraction when space charge effects have already begun their influence, and analyser components may be made larger to accept an expanded beam. The analyser focusing elements may also be tuned to tolerate space charge, although this typically also involves a substantial sacrifice of low space charge performance, possibly compromising the instrument.

One object of the present disclosure is to address the problems of space charge effects caused by dense ion packets within analysers (e.g. time-of-flight analysers), which can harm resolution and mass accuracy, and which are related to initial charge density. It is another object of the present disclosure to address other problems described above.

### SUMMARY

Against this background, there are provided apparatus for trapping ions according to claims 1, 11 and 19. For instance, numerous types of ion traps are provided, with embodiments relating to RF carpet extraction traps with any one or more of: dual-pressure trapping regions; ramped trapping fields during ion injection; and/or delayed extraction of ions after RF fields are quenched. Specific embodiments address problems related to the efficiency of trapping and transport of ions within the traps, in addition to the loss of resolution over an m/z range when such traps are coupled to mass analysers.

It should be noted that various aspects of the present invention may be combined. For example, the delayed extraction of any of claims 1 to 11 may be implemented in combination with: the DC trapping voltage that increases in magnitude over time of any of claims 12 to 21; and/or the dual-pressure apparatus for trapping ions of any of claims 22 onwards. Similarly, the DC trapping voltage that increases in magnitude over time of any of claims 12 to 21 may be implemented in combination with the dual-pressure apparatus for trapping ions of any of claims 22 onwards.

In some embodiments, extraction of ions from ion traps may be improved. For example, certain embodiments recognise that a particular problem with RF carpet extraction traps is that, because the RF pseudopotential strength of an RF carpet may be mass-dependent, ions of different m/z are trapped within the trap at differing distances from the RF surface. This can present a particular problem for extraction traps coupled to time-of-flight mass (ToF) analysers, because when ions are extracted from the trap into the ToF, ions having different m/z will have different starting positions within the trap and so different path lengths through the analyser. Thus, systematic m/z shifts may be introduced by the trap. To address this problem, when ions are to be extracted from the ion trap, the RF on the RF carpet may initially be quenched (i.e. turned off), and then an extraction pulse may be applied to the ion trap after a suitable delay period has expired. During the delay period, ions of different m/z move under the influence of a DC field (e.g. the original trapping field) into spatial focus, so that when an extraction voltage (e.g. an extraction pulse) is applied to the trap, ions having different m/z will have substantially the same starting height within the trap. Thus, delayed extraction can be used to pre-focus ions of different m/z, for matching focal planes, which can reduce systematic errors in m/z values obtained from ToF analysers coupled to the ion traps described herein. Hence, improved ion traps that eject planar ion clouds can be provided.

Moreover, the present disclosure recognises that another problem with RF carpet extraction traps is that ion entering the trap can be accelerated by the DC trapping field into the RF electrodes. Loss of ions may be undesirable. To address this problem, the DC voltage may be set to a low value while ions are being injected into the trap and may be subsequently raised or ramped over a period of time as ions cool within the trap. A gradual or slow step-up or ramp of the trapping voltage after ion injection can be used to limit pick up of energy by ions and gradually compress the ions onto the RF carpet. This can reduce the risk of loss of ions due to collisions with the RF carpet.

Additionally, some embodiments of the present disclosure relate to dual-pressure-type RF carpet extraction traps. That is, some embodiments provide extraction traps that have regions at different pressures. For instance, a gas restrictor, which may comprise an aperture (e.g. a slot for permitting ions to pass through), may be suspended from a top plate of an apparatus for trapping ions. This can facilitate straightforward construction and can allow RF electrodes to run undisturbed across the opposing bottom substrate of an RF carpet trap. In addition, a top plate in a trapping region (e.g. in a high-pressure region of a trapping region) may be formed with a wedge shape, which can allow for effective lateral focussing of ions to a small gas restricting aperture. Such dual-pressure extraction traps may be built on a PCB top-plate with a gas restrictor suspended therefrom.

Some embodiments of the present disclosure relate to the provision of one or more barrier electrodes positioned around a perimeter of a trapping region. Such barrier electrodes may be positioned on and may extend from the lower surface (e.g. the surface on which the array is provided, which is described herein as a first surface) of the trapping region. Barrier voltages may be applied to such barrier electrodes to trap the ions within the trapping region. Such trapping can be provided by DC electrodes, or RF electrodes, or electrodes fed with a combination of DC and RF. Trapping around the plane of an RF carpet via DC electrodes on a top plate may also be advantageous, in addition to or instead of barrier electrodes positioned on the lower surface.

In some aspects of the present disclosure, there may be provided: an apparatus for trapping ions, comprising: an array of electrodes, the electrodes of the array extending along a surface (which may be termed a first surface) of the apparatus; one or more further electrodes that are distinct from the array of electrodes; a trapping region for receiving the ions, defined by the array of electrodes and the one or more further electrodes; and a control circuit configured to: apply a set of oscillatory voltages to the array of electrodes to repel the ions from the array of electrodes, each electrode in the array of electrodes having a different phase to each adjacent electrode; apply a trapping voltage to at least one of the one or more further electrodes to force the ions towards the array of electrodes, the set of oscillatory voltages and the trapping voltage thereby trapping the ions within the trapping region; wherein the one or more further electrodes comprise one or more barrier electrodes positioned around a perimeter of the trapping region, and the control circuit is configured to apply a barrier voltage to the one or more barrier electrodes to trap the ions within the trapping region. Such barrier electrodes may comprise: DC electrodes positioned on a top plate, for example as electrodes surrounding an extraction region; and/or distinct electrodes arranged around a perimeter of a trapping region.

Moreover, the wedge-shaped electrodes described previously can be used to provide a funnelling effect in any type of apparatus for trapping ions, and are not limited to dual-pressure extraction traps. For example, in some aspects of the present disclosure, there may be provided: an apparatus for trapping ions, comprising: an array of electrodes, the electrodes of the array extending along a surface (which may be termed a first surface) of the apparatus; one or more further electrodes that are distinct from the array of electrodes; a trapping region for receiving the ions, defined by the array of electrodes and the one or more further electrodes; and a control circuit configured to: apply a set of oscillatory voltages to the array of electrodes to repel the ions from the array of electrodes, each electrode in the array of electrodes having a different phase to each adjacent electrode; apply a trapping voltage to at least one of the one or more further electrodes to force the ions towards the array of electrodes, the set of oscillatory voltages and the trapping voltage thereby trapping the ions within the trapping region; wherein the one or more further electrodes comprise a funnelling electrode and the control circuit is configured to apply the transport voltage to the funnelling electrode. A funnelling electrode may have a wedge-shape and can reduce the lateral separation of ions (i.e. narrow the ion cloud) and provide improved ion transport.

Hence, the present disclosure provides various concepts that improve trapping and transport of ions for RF carpet-based extraction traps. Some embodiments allow for a large, planar initial ion cloud suitable for extraction into a time-of-flight analyser. A delayed extraction type process is described between a quench of RF (i.e. when oscillatory voltages cease to be applied to the RF carpet) and application of the extraction field, between which only a small DC field is applied, which allows the trapped ion planes of different m/z to come into better alignment at the point of extraction and which therefore reduces mass-dependent resolution loss. Additionally, an ion loading mechanism is described that limits the pick-up of energy on injection of ions into the RF surface trap, and a dual-pressure structure with a low-pressure extraction region is proposed to limit gas leakage into the analyser.

Throughout this disclosure, where voltages are described as being applied to electrodes, it will be appreciated that corresponding electromagnetic fields are established. For instance, it will be understood that where the disclosure describes applying, e.g., an “extraction voltage” (or any other type of voltage) to one or more electrodes, this will lead to a corresponding “extraction field” being caused by that extraction voltage. Similarly, where the disclosure describes applying an “RF field” or a “DC field”, for instance, it will be understood that control circuitry is configured to apply appropriate RF or DC voltages to one or more electrodes to establish such fields.

The above-noted advantages and various other advantages will become apparent from the following description and accompanying figures.

### LISTING OF FIGURES

The present disclosure will now be described by way of example, with reference to the accompanying figures, in which:

FIG. 1 shows a quadrupole ion trap serving as the ion source for a reflectron time-of-flight analyser;

FIG. 2 shows a known RF carpet configured to act as an extraction trap;

FIG. 3 shows MR-ToF resolution and space charge for differing linear trap well depths;

FIGS. 4A to 4D show embodiments of different apparatus for trapping ions;

FIG. 5 shows an embodiment of a dual-pressure apparatus for trapping ions;

FIG. 6 shows a further embodiment of a dual-pressure apparatus for trapping ions;

FIG. 7 shows a top view of an embodiment of a dual-pressure apparatus for trapping ions;

FIG. 8 shows an embodiment of a mass spectrometry system;

FIG. 9 shows ion paths in a simulated apparatus for trapping ions;

FIG. 10 shows the form of a calculated pseudopotential for an apparatus for trapping ions;

FIG. 11 shows ion trajectories as the ions cool into a potential well over time;

FIG. 12 shows a simulated ion time spread after extraction; and

FIG. 13 shows the focusing effect on the positions of ions when using extraction pulses that are delayed after an RF quench.

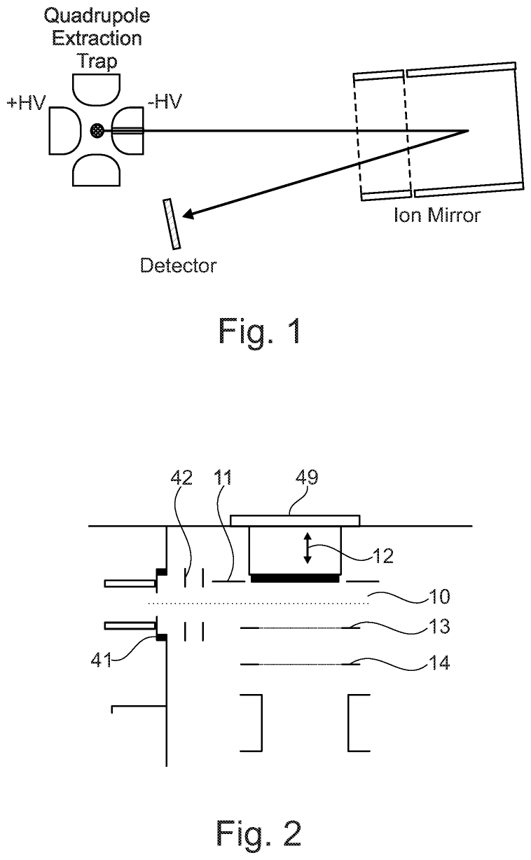

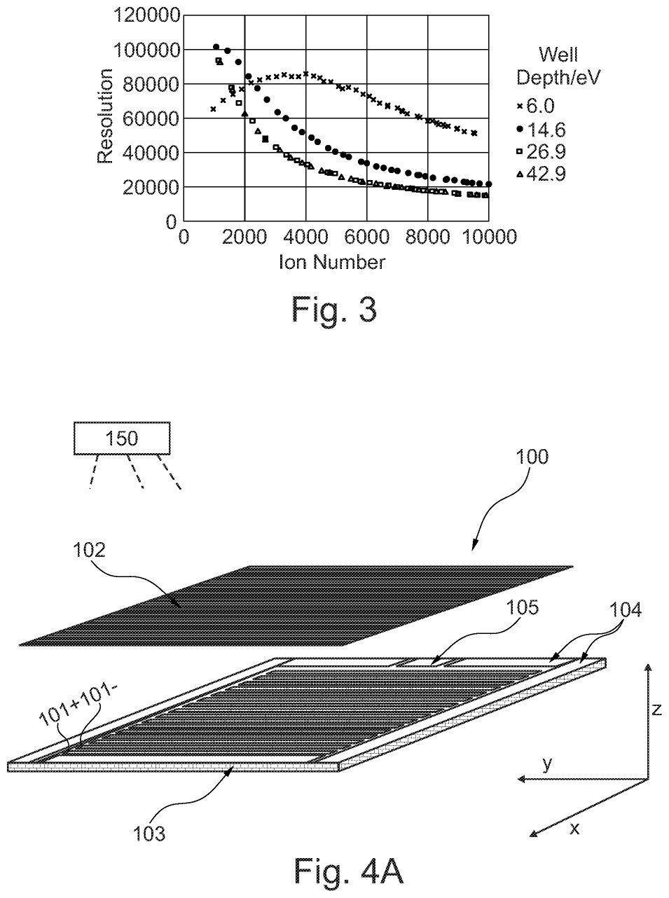

### DETAILED DESCRIPTION

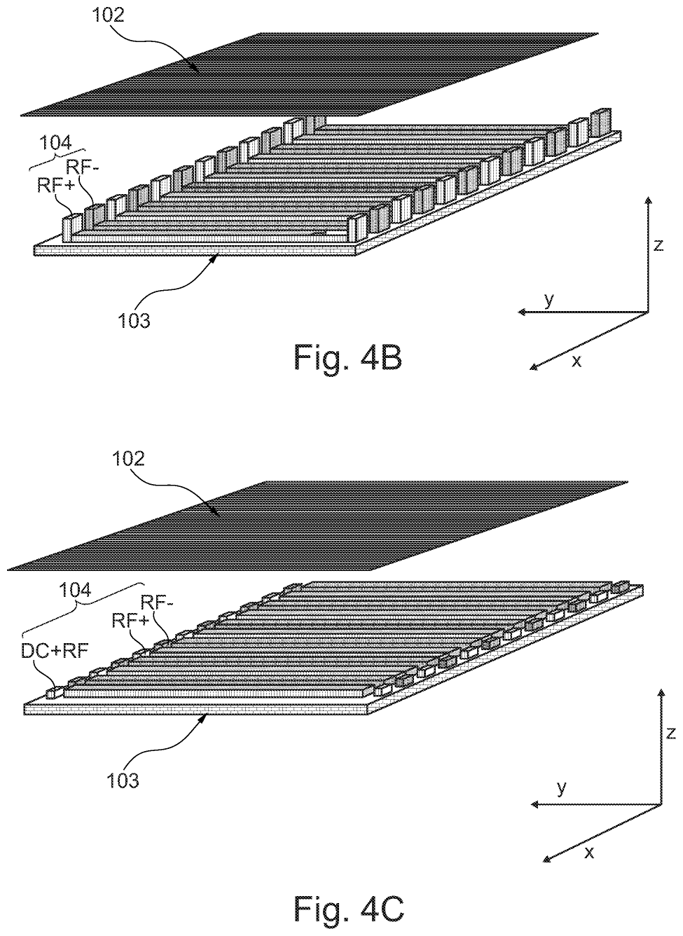

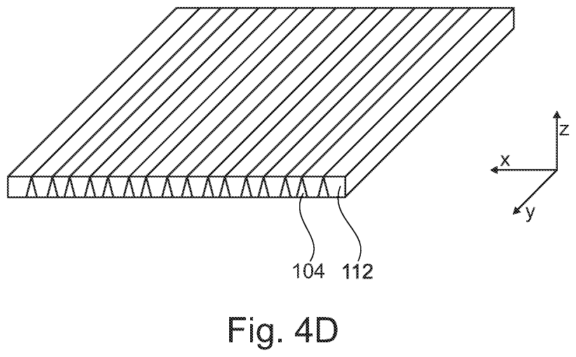

The present disclosure provides a number of different RF carpets. Various examples of the core structure of an RF carpet extraction trap 100 are shown in FIGS. 4A to 4C. Such an RF carpet extraction trap 100 is also described herein as an apparatus for trapping ions or as an ion trap.

FIG. 4A shows a basic embodiment of an apparatus for trapping ions. The apparatus comprises a series or array of RF electrodes 101+, 101− on a first surface, which is the lower surface of the apparatus, to provide an RF carpet. The RF electrodes 101+, 101− extend in the x- and y-directions. A further electrode 102 (which may be a gridded electrode) may be mounted above the RF carpet on a second surface. A small repulsive DC is applied on the further electrode 102 during trapping and a strong attractive DC is applied during ion extraction. Thus, the further electrode 102 acts as a trapping electrode 102 to which a control circuit 150 applies a trapping voltage during trapping (i.e. when the trapping voltage and oscillatory voltages are simultaneously applied to trap ions) and the electrode 102 acts an extraction electrode 102 to which the control circuit 150 applies an extraction voltage to extract ions. The trapping/extraction electrode 102 may also be described as a counter-electrode 102.

A control circuit 150 is shown, with its connections to the various electrodes in broken lines and truncated, for clarity. It will be understood that each embodiment may comprise such a control circuit 150. The control circuit 150 is capable of applying voltages to any of the electrodes and of receiving measurements from any sensors. The control circuit 150 may comprise logic for applying voltages to the various electrodes of the apparatus of the present disclosure. The control circuit 150 may also perform certain actions (e.g. adjust voltages on electrodes) based on received measurements (e.g. charge measurements in the trapping region). The control circuit 150 may be formed using conventional techniques and so is not described in further detail, for clarity and brevity.

In use, ions are trapped within a trapping region of the apparatus. The trapping region is defined by the array of electrodes and the one or more further electrodes. The surface on which the array of electrodes is arranged is preferably a substantially planar surface, but does not necessarily need to be perfectly two-dimensional or perfectly flat. The array of electrodes may extend in one or two directions. For example, the electrodes of the array may be positioned at various locations in the x- and/or y-directions. The individual electrodes of the array may be substantially one- or two-dimensional, in both cases having a relatively small spatial extent (thickness or height) in the z-direction. The array of electrodes may comprise a series of parallel line electrodes that each extend in the y-direction and which are spaced apart in the x-direction. That is, the array itself may be one-dimensional and each electrode may be one-dimensional, with the electrodes of the array collectively extending over a two-dimensional surface. In some embodiments, the array may be a two-dimensional array of points at different (x, y) positions, with a small line (one-dimensional) electrode or a small planar (two-dimensional) electrode provided at each (x, y) position of the array. In this case, the electrodes of the array of electrodes again collectively extend over a fraction of a two-dimensional surface (i.e. the lower surface on which the electrodes are arranged).

The height of the electrodes may be a small fraction (e.g. less than 10%, or less than 1%) of one or both of their widths. In the example shown in FIG. 4A, the RF electrodes 101+, 101− and the counter-electrode 102 are substantially planar and substantially parallel. Therefore, the trapping region is the region between the opposing first surface of the RF electrodes 101+, 101− and the second surface of the counter-electrode 102. Ions are preferably trapped in a narrow distribution of heights (z values) in a plane that is parallel to the plane of the RF carpet, which is parallel to the x-y plane.

Whilst for PCB designs, it is preferred that electrodes of the array are substantially two-dimensional, this is not essential. For example, an RF surface may be constructed from interlocking teeth of two etched and/or cut metal electrodes. These could be very deep for stability and may be provided without a heavy substrate. In some embodiments, thick electrodes may be glued/screwed (or attached using any other means) to a PCB rather than printed, to keep ions far away from the insulating surfaces, as in 4B and 4C.

FIG. 4D shows an example of an alternative structure for a lower array of electrodes 104, which can be used in place of any of the embodiments of FIGS. 4A, 4B and 4C, and which can also be used in subsequent embodiments. The structure in FIG. 4D can operate in the same way as the embodiments of FIGS. 4A to 4C. The electrodes 104 are each in the shape of a triangular prism and extend below the surface of the trapping region. Due to their tapered shape, the electrodes 104 would appear as a one-dimensional array of line-shaped electrodes in plan view. However, as can be seen in the perspective view in FIG. 4D, each electrode extends in the y-direction but also has a substantial, non-zero spatial extent in the z-direction. As shown in FIG. 4D, each electrode 104 may be embedded in a matrix 112, which replaces the PCB substrate 103 of FIGS. 4A, 4B and 4C.

Therefore, in general terms, the electrodes of the arrays of the present disclosure may be described as extending along a surface, which may be an interior surface of the trapping region. In some embodiments, this means that the electrodes may be disposed on a flat surface and the electrodes themselves are positioned on the flat surface and are substantially one- or two-dimensional, as in FIGS. 4A, 4B and 4C. However, the electrodes of the array of electrodes may be three-dimensional structures that extend along a surface (i.e. the electrodes may extend along the interior surface of the trapping region), and which also extend below the surface, as shown in FIG. 4D. The surface along which the electrodes extend may be described as a functional surface of the electrode, and this surface may be substantially flat and planar, and may be substantially parallel with the electrode(s) provided on an upper surface of the apparatus.

During operation, the RF electrodes 101+, 101− and the counter-electrode 102 work together to trap ions. The control circuit 150 applies a set of oscillatory (e.g. RF) voltages to the RF electrodes 101+, 101− to repel the ions from the array, and each electrode in the array of electrodes may have a different phase to each adjacent electrode. The array of electrodes may have a spacing (e.g. a shortest distance between any two adjacent electrodes) of: less than 5 mm; less than 3 mm; less than 1 mm; less than 0.1 mm; or less than 0.01 mm. Each electrode in the array of electrodes may have an opposite phase to each adjacent electrode. For example, each electrode may have an identical frequency to each neighbouring electrode but a 180° phase shift. The array of electrodes may be substantially planar.

The control circuit 150 also applies a trapping voltage to the counter-electrode 102, which forces ions towards the array of electrodes 101+, 101−. The trapping voltage may be activated or applied only after the ions have entered the trapping region. The combined action of the voltages traps the ions within the trapping region of the apparatus. For instance, the RF electrodes 101+, 101− and the counter-electrode 102 may work in a conventional manner, with a closely-packed array of electrodes forming a pseudopotential barrier across the first surface over which the array of electrodes are spread, and ions being pinned against this pseudopotential surface by a DC electrode mounted on a second surface that is opposite the first surface and the array of electrodes, causing ions to spread across the trapping region. The trapping voltage may be a DC voltage that may have a magnitude that is smaller than a magnitude (e.g. absolute value or RMS magnitude) of the oscillatory voltages applied to the array of electrodes.

When it is desired to remove ions from the apparatus, an extraction voltage is applied to one or more electrodes of the apparatus to establish a potential gradient in the trapping region that leads to the extraction of ions. For example, the control circuit 150 may apply an extraction voltage to at least one of the array of electrodes (RF electrodes 101+, 101−) and/or one or more further electrodes (e.g. the counter-electrode 102, or some other electrode) to extract the ions from the trapping region. Extraction voltages could be applied to more than one electrode, using a push/pull configuration (e.g. pushing by the RF carpet and pulling by the extraction electrode), for example.

Hence, in generalised terms, at least one electrode of the apparatus, such as one at least one electrode of the array of electrodes and one or more further electrodes, may be an extraction electrode and the control circuit may be configured to apply an extraction voltage to the extraction electrode. The extraction electrode may act only on a low-pressure region of the apparatus. Application of the extraction voltage to an extraction electrode may release ions from the trapping region. In preferred embodiments, the extraction electrode may be opposite the array of electrodes and the extraction electrode is preferably substantially parallel with the array of electrodes. The extraction electrode and the array may both be substantially parallel planar structures. The extraction electrode may comprise one or more apertures (e.g. any opening or hole) for allowing ions to pass therethrough. For instance, a gridded structure may be provided. The extraction electrode may therefore be a gridded electrode, and/or a segmented electrode, comprising a plurality of apertures for allowing ions to pass therethrough. Preferably, the extraction voltage has a greater magnitude than a magnitude of the trapping voltage.

Certain aspects of the present disclosure relate to delayed extraction of ions and to gradual ramping of the trapping voltages. For instance, ions may be trapped in the trapping region by the combined action of the electrodes 101+, 101− and 102 in the manner described previously. To prevent ions that enter the trapping region from colliding with the electrodes 101+, 101− when the trapping voltage is turned on, the trapping voltage may be gradually ramped up. For instance, the trapping voltage may increase in magnitude over time, which can prevent ions from being accelerated into the lower electrodes 101+, 101−. That is, ions may be allowed to thermally cool after they enter the trapping region before the trapping voltage reaches its maximum value.

Moreover, a focusing voltage may be applied in the trapping region to reduce the spread of the ions in the z-direction, prior to extraction. For instance, the RF voltages on the electrodes 101+, 101− may be quenched during a delay period and during that delay period, a focusing voltage (which may simply be the same voltage as the trapping voltage) may be applied to one or more electrodes (e.g. any one or more of electrodes 101+, 101−, 102, and/or 108) to focus the ions. The delay period might have a duration of: from 0.1 μs to 2 μs; or from 0.1 μs to 1 μs. However, other durations can be used depending on the sample in question.

Then, after the ions have been focused, the ions may subsequently be extracted from the trapping region by application of an extraction voltage to the upper electrode 102. For example, application of a set of oscillatory voltages (e.g. voltages applied to the RF carpet 101+, 101−) and the trapping voltage (e.g. electrode(s) 102) may be such that the ions are positioned at a range of distances from the array of electrodes. Then, application of the focusing voltage may reduce the range of distances from the array of electrodes at which the ions are positioned. This can improve the properties of the ion cloud, which can be advantageous in reducing m/z shift when the trap is coupled to a mass analyser.

It should be noted that a small attractive DC may be applied to the electrodes 101+, 101− to provide the focusing voltage. However, as this voltage may be defined relative to the counter-electrode (e.g. electrode 102) the equivalent effect is that the counter-electrode has a repulsive DC voltage (i.e. causing a focusing voltage that repels ions away from the counter-electrode and towards the array of electrodes). Thus, DC voltages may be applied to the entire set of electrodes to create a focusing field that pushes ions down onto the array of electrodes.

The RF electrodes 101+, 101− may be printed onto a PCB substrate 103, or may comprise solid electrodes glued or otherwise mounted to a support. The electrode structure may also comprise two interlocking combs, in the manner of the Planar Multipole Ion Trap described by Debatin et al, Physical Review A, 2008, 77, 033422, which is incorporated herein by reference. The substrate 103 material may comprise, for example, PCB, glass, ceramic or plastic, and need not cover the entire first surface of the electrode structure. The substrate 103 may be of sufficient size to hold the various components attached thereto in their intended positions.

The width and separation of the RF electrodes 101+, 101− may vary greatly, from low-mm and sub-mm scale spacing potentially down to micron level electrodes etched out via lithographic methods. Generally, the smaller and more numerous the electrodes 101+, 101− are, the stronger the decay of the pseudopotential and the closer ions come to the electrodes 101+, 101−. This is highly advantageous if ions travel through restricted spaces, such as gas restricting regions. For extraction traps, a strongly decaying pseudopotential brings ions of similar m/z closer together and better compresses the ion packets, allowing very strong time foci to be achieved. On the flip side, very high frequency RF (e.g., 10 MHz or higher) is required rather than ˜1 MHz level for the conventional mm scale, and such proximity to electrodes risks problems from surface charge, contamination, and losses of unthermalised ions during injection. Thus, the most appropriate electrode spacing for any given application will depend on a variety of factors and aspects of the present disclosure are not limited to any particular scale.

To prevent ions escaping over the sides of the trap, a potential barrier may be provided by one or more barrier electrodes 104. The apparatus for trapping ions described herein may have a longitudinal axis extending in a longitudinal direction (i.e. in the x-direction) and a plurality of barrier electrodes 104 may be spaced apart in the longitudinal direction. Any electrode that provides lateral (i.e. perpendicular to the z-direction that is perpendicular to the plane of the RF carpet) trapping of ions in the trapping region may be considered a barrier electrode. For example, a DC or RF barrier 104 may be provided that extends at least to the height (i.e. in the z-direction) above the RF electrodes 101+, 101− that ions occupy during trapping. FIGS. 4A, 4B and 4C show examples of barrier electrodes 104 provided via PCB printed DC electrodes, raised RF electrodes (which may be segmented but which are not necessarily segmented), and DC superimposed onto RF electrodes. In particular, FIG. 4A shows PCB printed electrodes, which comprise DC barrier electrodes 104 and gate 105 electrodes. FIG. 4B shows solid barrier electrodes 104 mounted to a substrate 103, with raised regions, denoted by RF+, RF−, provided as side-guards. FIG. 4C shows raised barrier electrodes 104 with segmented side-guard electrodes with superimposed DC, which are denoted as DC+RF.

Various combinations of the barrier electrodes 104 in FIG. 4 can be provided. For example, the barrier electrodes of FIG. 4A can be combined with the barrier electrodes of FIG. 4B and/or FIG. 4C. Similarly, the barrier electrodes of FIG. 4B can be combined with the barrier electrodes of FIG. 4A and/or FIG. 4C. Various types of electrodes may be disposed around the perimeter of the trapping region to serve as barrier electrodes, and any voltage applied to such a barrier electrode may be described as a barrier voltage.

The raised electrodes of the barrier electrodes 104 in FIGS. 4A to 4C should not be raised unnecessarily high because they may interfere with the extraction field, which is otherwise very strong and linear in preferred embodiments. Also shown among the PCB printed DC electrodes is a small DC electrode 105 to act as a gate and allow ions to enter the trap 100 via an ion inlet, from upstream ion optics.

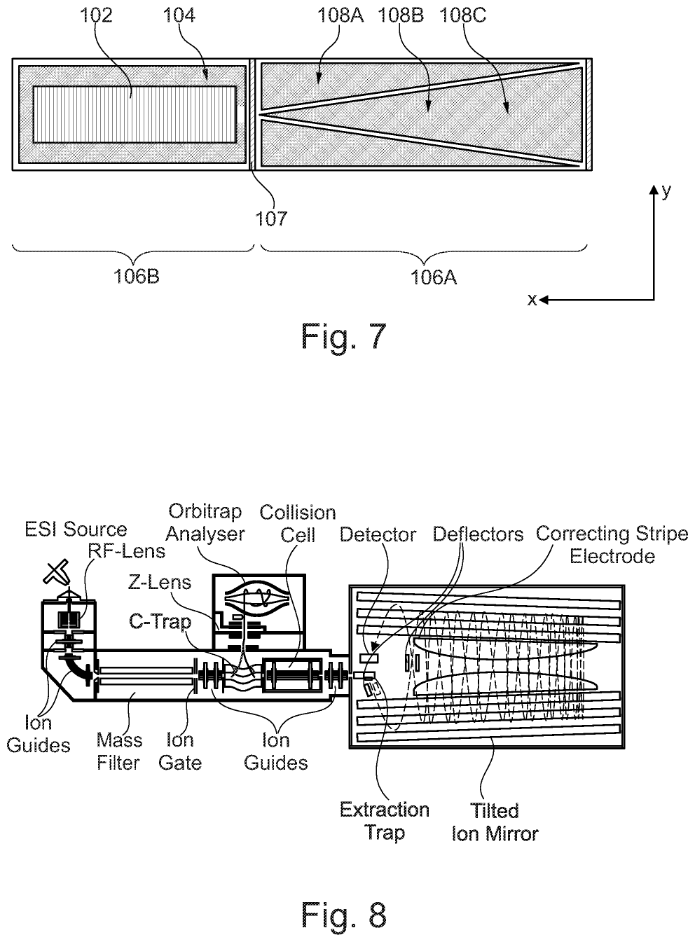

The barrier electrodes may be described in a general sense as one or more further electrodes (distinct from the RF carpet, or array of electrodes) that are positioned around a perimeter of the trapping region. For example, the barrier electrodes may be on the same substrate as the array of electrodes, but positioned around the edge of the array of electrodes. The control circuit may be configured to apply a barrier voltage to the one or more barrier electrodes to trap the ions within the trapping region. The barrier electrodes may therefore provide lateral trapping in the x-y plane. It should be noted that one or more barrier electrodes may be provided on a different substrate, such as a top plate, as will be described in further detail in relation to FIG. 7.

In use, the control circuit will preferably apply the set of oscillatory voltages to the array of electrodes and the trapping voltage to the trapping electrode such that the ions are positioned at a first range of distances from the array of electrodes. This range of distances will preferably be a narrow range of z-values for a substantially planar ion cloud. Preferably, the barrier voltage might define a potential barrier (e.g. to laterally confine the ions in the trapping region) that extends to at least the first range of distances from the array of electrodes. For example, the potential barrier should preferably extend to at least the highest value (i.e. the greatest height in the z-direction) of the first range of distances to ensure that no ions are lost. However, it might be acceptable for the potential barrier to extend to a smaller z-value if some loss of ions is acceptable.

The barrier voltages can take many forms. For example, the control circuit may be configured to apply any one or more of: a DC barrier voltage to at least one of the one or more barrier electrodes; a radio frequency, RF, barrier voltage to at least one of the one or more barrier electrodes; and/or a superposition of a DC barrier voltage and an RF barrier voltage to at least one of the one or more barrier electrodes. In some cases, the one or more barrier electrodes may comprise a plurality of barrier electrodes. The control circuit may be configured to apply barrier voltages having opposite phases to adjacent barrier electrodes. This may create a pseudopotential. One or more of the plurality of barrier electrodes may be positioned at an end of an electrode of the array of electrodes. Such an arrangement may ensure that ions are trapped within the trapping region and cannot move beyond the edges of the RF carpet.

Regardless of the nature of barrier electrodes used, the length and width of the trap 100 may be matched to the acceptance of the analyser. For example, a regular ToF analyser with a large gridded reflectron may accept a relatively large initial ion packet, even perhaps 10×10 mm, whereas MR-ToF analysers may have much stricter limitations, for example 10×1 mm. Important is overall phase space acceptance, not simply initial spatial distribution. Moreover, while the RF electrodes 101+, 101− are shown as being rectangular, other shapes could be used. For example, a circular (or any other shape) RF carpet may be employed instead. The counter-electrode 102 may be provided with the same shape as the RF carpet or a different shape and hence may also be rectangular or circular, or any other shape.

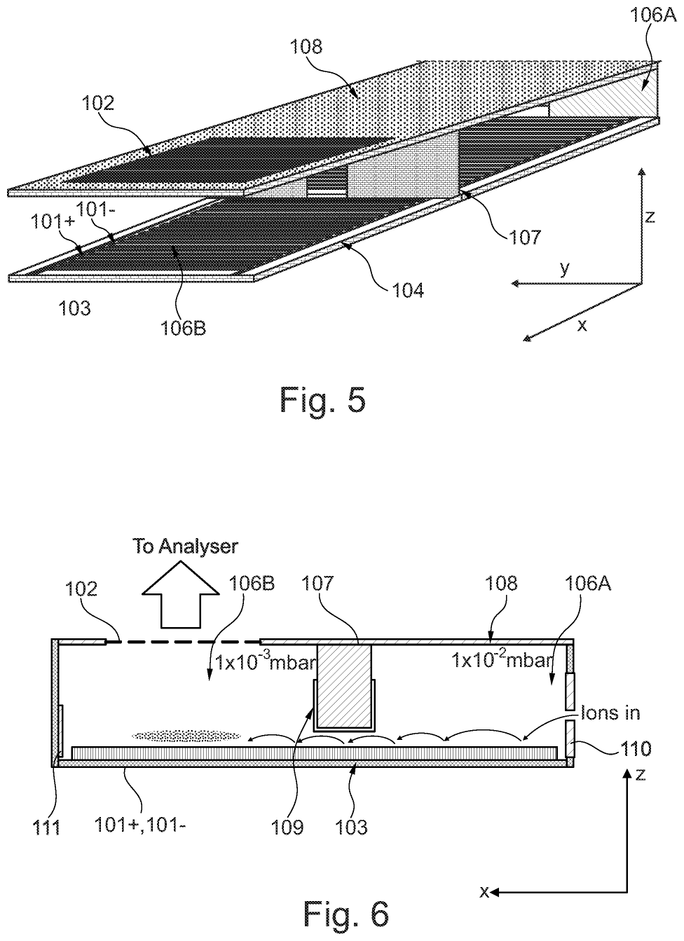

FIG. 5 shows a further embodiment, which is an adaptation to an RF carpet trap of the type described by Giles in US-2019/0103263A1. In the embodiment of FIG. 5, the RF carpet electrodes 101+, 101− pass through two distinct regions 106A, 1068, which are at different pressures, and which are separated by a gas restrictor 107. The gas restrictor 107 may be configured to restrict gas flow from the higher-pressure region to the lower-pressure region and may have an aperture to allow ions to pass therethrough. In generalised terms, the array of electrodes may extend along, for example, one or more edges (e.g. the lowermost surface) of the relatively low-pressure region of the trapping region and along one or more edges (e.g. the lowermost surface) of the relatively high-pressure region of the trapping region, which may allow ions to be trapped continuously as they move alongside the array of electrodes. For instance, the array preferably extends along the lower surface (i.e. the first surface, which is opposite the extraction plate) of the low- and high-pressure regions. This may mean that the array runs along the entirety of at least one side of the low- and high-pressure regions.

In FIG. 5, the counter-electrode 102, which serves as an extraction electrode, covers only the extraction region 1068, and it is preferred (but not essential) that the remainder of the trapping region (i.e. the high-pressure region 106A) should be served by a separate transport electrode 108 on the top plate. The transport electrode 108 also applies a trapping voltage at certain times and so may sometimes be described as a trapping electrode. Such a separate electrode 108 on the top plate may be electrically separate (i.e. electrically isolated) from the extraction electrode 102, which allows ion packets to be processed in parallel in both regions 106A, 1068, thereby improving throughput. Sidewalls for gas containment are not shown but can be provided in a conventional manner. Thus, in a general sense, the trapping region may have a relatively low-pressure region and a relatively high-pressure region, and the extraction electrode may extend along the relatively low-pressure region (but need not extend along the high-pressure region). In some cases, the extraction electrode may extend along the high-pressure region, if a mechanism for transporting ions along the trap is provided (e.g. travelling wave, or DC gradient applied to RF electrodes). This can provide a low-pressure extraction trap with an upstream high-pressure region for cooling ions (or for serving as a collision or fragmentation cell). Providing a low-pressure extraction region can limit gas leakage into the analyser, which can improve analysis of samples.

FIG. 6 shows a cross-sectional view of the trap 100 concept shown in FIG. 5, with more details illustrating how the apparatus can be used as a dual-pressure trapping region incorporating an RF carpet, which can be used for high-throughput processing of ions. In FIG. 6, additional details are shown, such as one or more electrodes 109 that may be applied to the gas restrictor 107 and an entrance aperture 110 (also termed an ion inlet).

Optionally, at the end of the RF electrode series 101+, 101−, an end DC repeller or charge collecting surface 111 may be provided for optional charge measurement independent of the analyser, which may be used for control of ion population in the trapping region. For instance, measurements of the charge within the trapping region can be used to control the gating of an ion inlet. In generalised terms, the apparatus may comprise a charge detector, such as a charge collecting surface, which may be used for charge measurement (e.g. independent of the analyser). Such a charge detector may be provided in a low-pressure region or a high-pressure region, or one or more detectors could be provided in both regions. The control circuits described herein may use data from such detectors for measuring ion population and controlling inlet of ions.

An advantage of this design over existing traps is simplicity of construction, because the series of RF electrodes 101+, 101− can run undisturbed across the substrate 103, whilst the gas restrictor 107 may simply be suspended from the top plate. Because the RF on the electrodes 101+, 101− is relatively low, the restrictor 107 may be positioned close enough (e.g. within several mm, such as 2 mm, although other distances can be used) to the array of electrodes 101+, 101− to serve effectively. It may also be that one or a plurality of the RF electrodes 101+, 101− are relatively narrow (e.g. in the y-direction) in the region of the restrictor 107, both to allow the restrictor to contact the substrate 103 and to focus ions through a narrowed slot in the restrictor 107.

In general terms, therefore, the disclosure may provide an apparatus for trapping ions comprising a second surface (e.g. a top plate, which may be a second surface of the apparatus), the second surface opposing the array of electrodes (which are provided on a first surface), and a gas restrictor may extend towards the array of electrodes from the second surface. This can effectively divide the trapping region between the trapping electrode and the array of electrodes into two distinct regions which can be held at different pressures.

High-pressure regions are preferably able to cool ions in a reasonable time, so preferred pressures for the high-pressure regions are >1×10⁻³ mbar and ideally >2×10⁻³ mbar. If fragmenting ions, the high-pressure region may be at >5×10⁻³ mbar. In some embodiments, an upper pressure limit may be 2×10⁻² mbar, although higher pressures can be used in certain circumstances.

For the low-pressure region, in order to stop ions, >5×10⁻⁴ mbar or thereabouts is preferred, and preferably 1×10⁻³ mbar to stop ions quickly. Pressures of up to 5×10⁻³ mbar can be used, but at high pressures, ions scattering becomes problematic and may impair performance. For instance, the relatively low-pressure region may have a pressure of from 0.5 to 2×10⁻² mbar; and/or the relatively high-pressure region may have a pressure of from 0.5 to 2×10⁻³ mbar. Other pressures can be used depending on the specific application.

One or more electrodes of the array may be truncated, or relatively narrow near the gas restrictor. For example, the one, two, three or N (where N can be any number) electrodes that are nearest the restrictor may be narrower than neighbouring electrodes. A channel defined by the array of electrodes may become narrower (e.g. in the y-direction, perpendicular to the longitudinal axis of the apparatus) near the restrictor, so the gas restrictor does not need to have too wide a hole.

The two regions 106A, 106B are typically at pressures of 0.5-2×10⁻² mbar and 0.5-2×10⁻³ mbar respectively, although other pressures can be used. Hence, the relatively high-pressure 106A region may be at a pressure that is (at least) an order of magnitude higher than the pressure of the relatively low-pressure region 106B. This gives the higher-pressure region 106A sufficient pressure not only to cool 7 eV ions, but also to serve as a fragmentation cell for isolated ions in a tandem mass spectrometer. That is, the dual-pressure traps can be incorporated into mass spectrometry systems comprising mass analysers, such as tandem mass spectrometers.

A voltage (e.g. a DC voltage) may be applied to the restrictor 107, to trap ions in the higher-pressure side 106A, attract ions to the lower-pressure side 106B, or set to match the field strength on one or other side and effectively be invisible to ions. That is, in general terms, a control circuit may be configured to apply a voltage to the gas restrictor (e.g. to an electrode mounted on the restrictor, or to the restrictor itself) to: trap ions in the relatively high-pressure region; and/or transport ions to the relatively low-pressure region; and/or match an electric field strength in the relatively high-pressure region and/or the relatively low-pressure region. The gas restrictor may therefore function as a transport electrode that causes ions to be transferred between different regions of the apparatus.

Ion transfer along the trapping region (e.g. to move ions between the regions 106A, 106B) may be accomplished in various ways. For example, ions may be moved using voltages applied to the gas restrictor as mentioned previously. Additionally, ions may be transported by applying a transport voltage to one or more other electrode(s) of the apparatus. For example, DC gradients may be applied to the RF electrodes 101+, 101−, by segmentation of the electrode 108 mounted or printed to the top plate, or via application of a superimposed travelling wave to the RF electrode series 101+, 101−, either as a train of DC pulses (as described in U.S. Pat. No. 6,791,078B2, which is incorporated herein by reference) or as RF (as described in U.S. Pat. No. 6,894,286 B2, which is incorporated herein by reference). A travelling wave may have the benefit of reducing or minimising pick up of energy by the ions during transport, potentially allowing extraction of a near-thermalised ion cloud (though with some residual axial velocity that the analyser should be able to deal with, for example with a deflector) without needing time to stop and cool the ions in the low-pressure extraction region 1068. In this way, up to 1KHz operation is possible. Hence, the RF electrodes 101+, 101− may, in certain cases act as transport electrodes, whilst various other electrodes such as the electrode 108 can also have transport voltages applied thereto and so may also act as transport electrodes. It should also be noted that combinations of these different approaches may also be combined to effect ion transport.

Hence, in generalised terms, at least one of the array of electrodes and the one or more further electrodes may be a transport electrode. The control circuit may be configured to apply a transport voltage to the transport electrode to transport ions along the trapping region (i.e. cause the ions to move). The transport electrode may be any electrode that performs this function and the transport electrode may perform other functions (e.g. trapping of ions, or focusing of ions) at other times. The transport voltage may have a DC gradient configured to transport ions along the DC gradient. The transport voltage may be a DC voltage, or an AC voltage with a DC offset. The transport voltage may also be a time-varying voltage having a DC offset, with a time-averaged DC gradient that causes transport of ions. In some cases, the transport voltage may comprise a travelling wave (e.g. applied to an RF carpet) configured to transport ions in a direction of the travelling wave. The control circuit may be configured to superimpose the travelling wave voltage onto the set of oscillatory voltages. In this way, trapping can be maintained while the superimposed travelling wave causes ions to move along the trapping region without releasing the ions, which can reduce loss of ions. In some embodiments, the control circuit may be configured to apply the transport voltage to the array of electrodes or to any other electrodes.

It will be understood that the embodiments in FIGS. 4A-4C, 5 and 6 show specific examples of an advantageous implementations of the present invention. However, it will be appreciated that the principles can be applied more generally. For example, the present disclosure advantageously provides an apparatus for trapping ions, comprising: an array of electrodes, the electrodes of the array extending along a (first) surface of the apparatus; one or more further electrodes that are distinct from the array of electrodes; a trapping region for receiving the ions, defined by the array of electrodes and the one or more further electrodes, the trapping region having a relatively low-pressure region and a relatively high-pressure region; and a control circuit configured to: apply a set of oscillatory voltages to the array of electrodes to repel the ions from the array of electrodes, each electrode in the array of electrodes having a different phase to each adjacent electrode; and apply a trapping voltage to at least one of the one or more further electrodes to force the ions towards the array of electrodes, the set of oscillatory voltages and the trapping voltage thereby trapping the ions within the trapping region. By providing a trapping region having a relatively low-pressure region and a relatively high-pressure region, improved cooling of ions in an RF carpet can be achieved. Moreover, gas leakage from the extraction region can be reduced if the extraction region is held at relatively low pressure.

Ions entering the apparatus may be energised by the field from the top-plate 108 DC, as there is no central axis to inject down. Since this creates some risk that ions will be accelerated into the RF electrodes 101+, 101−, it may be advantageous for this repulsive DC to be set low during ion injection, ˜1V for example, and raised or ramped up as ions cool, for example to 10V over 2 ms. Hence, in another generalised aspect of the present disclosure, a control circuit may be configured to apply a trapping voltage to at least one of the one or more further electrodes to force the ions towards the array of electrodes, the set of oscillatory voltages and the trapping voltage thereby trapping the ions within the trapping region, and the trapping voltage may be a time-varying DC voltage that increases in magnitude over time. Such a time-varying trapping voltage can allow ions to cool before the trapping field is applied. Hence, the trapping voltage may have a relatively low magnitude (i.e. the trapping voltage may cause a weak trapping field to be applied) while ions are injected into the trapping region and may increase in magnitude after the ions are injected into the trapping region. Hence, ions may be trapped gradually.

The magnitude of the trapping voltage while ions are injected into the trapping region may be less than 5V, less than 3V, less than 2V, or less than 1.5V. Thus, the voltage may be kept low while ions enter the trapping region and are allowed to cool. The magnitude of the trapping voltage may increase at a rate of at least 1×10³ Vs⁻¹, at least 2×10³ Vs⁻¹, or at least 5×10³ Vs⁻¹. The magnitude of the trapping voltage may continuously increase over time and the magnitude of the trapping voltage may linearly increase over time. A discontinuous (e.g. stepped) increase in magnitude could also be provided.

The trapping voltage may increase in magnitude over time until reaching a maximum voltage. For example, the magnitude of the trapping voltage may be constant after reaching the maximum voltage. Thus, ions may be gradually trapped and then confined once a certain voltage has been reached. The maximum voltage may be at least 5V, at least 10V, or at least 20V. Hence, the trapping voltage may reach a maximum voltage after at least 1 ms, at least 2 ms, or at least 3 ms. The maximum voltage and the time to reach the maximum voltage may depend on the nature and/or number of ions to be trapped. Information about the number of ions in the trapping region may be used to control the trapping voltage. Such information could be provided by a sensor in the trapping region. An upper limit for the delay period may be 20 ms, although any length delay can be used.

Turning next to FIG. 7, a specific example of a top plate for the dual-pressure trap is shown. Here, the plate is a PCB with an extraction electrode 102 glued to a hole in the plate. Barrier electrodes 104 are provided in the form of DC electrodes 104 that surround the gridded extraction electrode 102 either with the grid voltage applied, or with a separate voltage, to guard the sides of the RF carpet 101+, 101− from ion escape. Positions in the plate are shown to attach the gas restrictor 107 or apertures.

FIG. 7 also shows that the DC electrode 108 above the high-pressure region 106A is laterally divided into wedge-shaped portions 108A, 108B and 108C. By applying slightly higher DC to the outer electrode portions 108A, 108C, ions may be funnelled towards the centre, allowing the gas restrictor 107 to have a narrower slot. In the embodiment shown, there is no longitudinal segmentation of these electrodes 108A, 108B and 108C, so in this case the RF electrodes 101+, 101− may have a voltage applied to propel the ions across the trap 100 (i.e. guide ions in the x-direction). However, any one or more of the portions 108A, 108B, 108C of the electrode 108 may instead be longitudinally-segmented (e.g. in the x-direction) to provide ion transfer along the x-direction.

As the wedge-shaped portions 108A, 108B and 108C can be configured to transport ions along the trapping region, the electrode 108 may be described in general terms as a transport electrode. Similarly, the wedge-shaped portions 108A, 108B and 108C may be described as transport electrode portions. Moreover, because the wedge-shaped portions 108A, 108B and 108C of the electrode 108 act to funnel ions, the electrode 108 and the wedge-shaped portions 108A, 108B and 108C are also described herein as a funnelling electrode and funnelling electrode portions. The funnelling electrode 108 may funnel ions as the Ions move along the trapping region. This may mean that the separation of the ions in the y-direction is reduced due to the fields generated by the transport voltage (also described as a funnelling voltage). The application of such voltages reduces the spread of ions in the y-direction (i.e. perpendicular to their general direction of travel and perpendicular to the z-direction of the carpet trap). This improves the handling of ions by confining ions more closely, by reducing their lateral separation as they move along the trapping region. Moreover, in dual-pressure trapping regions, applying a funnelling voltage allows a narrower aperture to be used between regions of different pressures, due to the reduced lateral extent of the ion cloud. This can allow greater pressure differentials to be established.

As described previously, the wedge-shaped portions 108A, 1088 and 108C may be substantially triangular. The shape of and the voltages applied to the wedge-shaped portions 108A, 1088 and 108C may provide a funnelling or tapering effect on the ions. In a general sense, the apparatus may comprise an ion inlet for allowing ions to enter the trapping region, and the funnelling electrode may comprise a first portion and a second portion, with the first portion of the funnelling electrode being tapered away from (i.e. widest near to) the ion inlet. Equivalently, the first portion may be described as tapered towards the gas restrictor. The second portion may comprise one or more further tapered (e.g. wedge-shaped) portions that are tapered towards the inlet (or equivalently, narrowest near to the inlet). The second portion preferably comprises two wedge-shaped portions, such that the funnelling electrode comprises a first portion tapered away from the ion inlet and second and third portions that are both tapered towards the ion inlet. The first and second (and optionally third) portions of the funnelling electrode are preferably (substantially) coplanar. For instance, the portions of the funnelling electrode may collectively constitute the portions of a rectangular funnelling electrode. To achieve a funnelling action, the control circuit may be configured to apply a higher voltage to the second portion of the funnelling electrode than to the first portion of the funnelling electrode. A funnelling effect could also be provided with appropriate timing circuitry and segmented funnelling electrode.

In the general terms used previously, it will be noted that the apparatus described herein may comprise a second surface (e.g. top plate), the second surface opposing the array of electrodes, and the second surface may comprise any one or more of: an extraction electrode; a transport electrode; and/or a funnelling electrode. As mentioned previously, electrodes can perform different functions at different times, depending on the voltages applied, so the funnelling electrode may also act as a transport electrode, or separate funnelling and transport electrodes may be provided. In any event, the extraction electrodes described herein preferably serve relatively low-pressure regions of the trapping region, and may be positioned adjacent the low-pressure regions and away from the high-pressure regions. It is preferred that funnelling electrodes serve relatively high-pressure regions, but funnelling electrodes could also be used in low-pressure regions or in single-pressure apparatus. Transport electrodes and RF carpet electrodes preferably serve all regions (e.g. low-and high-pressure regions) to move ions along the whole apparatus. Preferred embodiments include an ion inlet for allowing ions to enter the trapping region, and the control circuit may be configured to apply a voltage to at least one of the one or more further electrodes (i.e. not the RF carpet) to allow ions to enter the trapping region through the ion inlet and/or to prevent ions entering the trapping region through the ion inlet.

FIG. 8 shows an example instrument incorporating an embodiment of the present disclosure. A hybrid mass spectrometer of the type described in U.S. Pat. No. 10,699,888B2 is shown in combination with a quadrupole mass filter, an orbital trapping mass analyser and the multi-reflection time-of-flight mass analyser described in detail by Grinfeld in U.S. Pat. No. 9,136,101B2. The RF carpet extraction trap substitutes for the existing extraction trap that feeds the MR-ToF analyser. In a general sense, the instrument in FIG. 8 may be described as a mass spectrometry system comprising: an apparatus for trapping ions according to any of the embodiments described herein; and a mass analyser configured to receive ions from the apparatus for trapping ions. Preferably, the mass analyser is a time-of-flight mass analyser (e.g. a MR-ToF analyser).

### Simulation Results

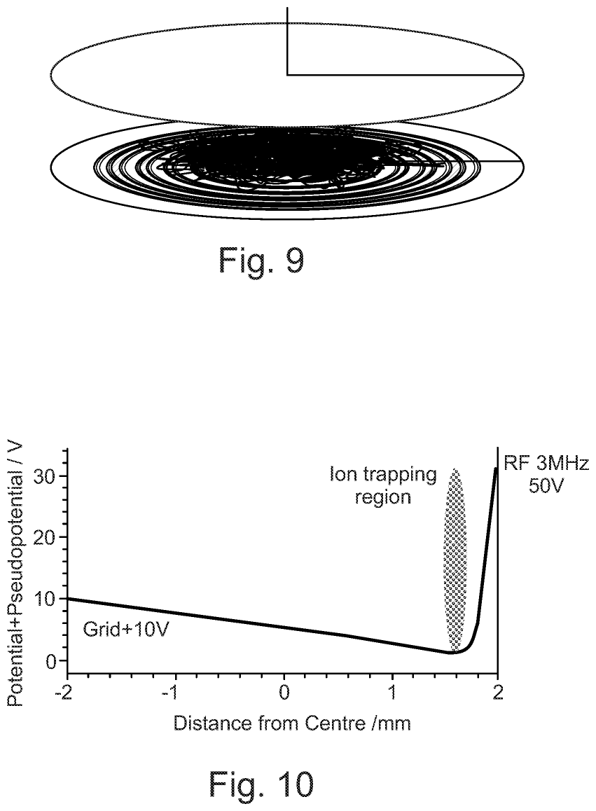

A simulation was constructed in the MASIM3D program, for an extraction trap with 0.4 mm wide RF electrodes (2D array) separated by 0.2 mm, guarded at the end by a 1.8 mm wide DC barrier electrode. The trap was chosen to extend 10 mm from the centre, with a distance of 4 mm from the RF array of electrodes to the upper grid-electrode (trapping electrode). Axial symmetry was used to create a circular trap from a 2D model, and an image of this trap with trajectories of a bunch of m/z 200 ions, spawned at the centre and allowed to cool in 1×10⁻² mbar background gas, is shown in FIG. 9. 3 MHz, 50V RF was applied along with +10V on the grid (trapping) electrode, and +5V on the outer barrier electrode.

FIG. 10 shows a plot of the potential well (for m/z 200 ions) created by the superimposed RF pseudopotential due to the array of electrodes and the repulsive DC from the trapping electrode. The potential well (DC plus RF pseudopotential) between the RF electrodes (+2 mm) and top grid (−2 mm) is shown and the region where ions settle is marked. This well structure is characteristic to this style of ion trap or guide and is similar to that shown in U.S. Pat. No. 6,683,301B2.

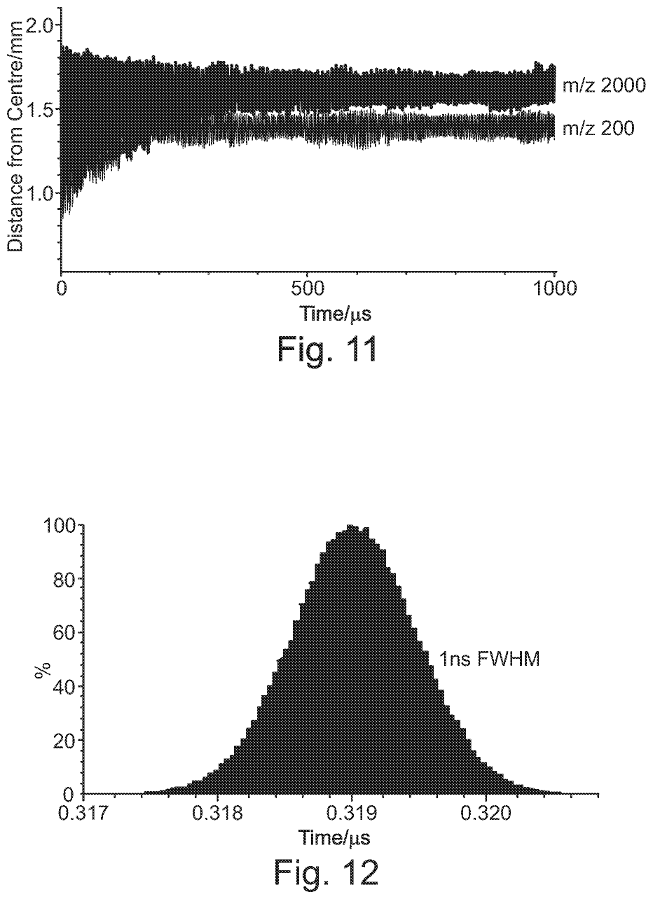

FIG. 11 shows trajectories of ions of m/z 200 and 2000 as they cool into the potential well over time. It can be observed that the spread of ion positions is small, being approximately −0.2 mm, and m/z 2000 sits at a very different average location to m/z 200 as a result of the difference in balance between pseudopotential strength and counter-potential from the grid +10V. Thus, it can be seen from the cooling ion trajectories for m/z 200 and 2000, that differing average height positions are obtained.

FIG. 12 shows a simulated ion time spread at the first time focus of a 0.1 mm (1 sigma) thick plane of m/z 200 ions, immediately after extraction by a 500V/mm field, equivalent to −2 KV on the extraction grid. It can be seen that the time spread full-width-half-maximum is almost exactly 1 ns, which is suitable for time-of-flight applications. High fields can readily be applied with stronger extraction voltages, or with opposite polarity voltage also applied to the RF electrodes. When the ion start point was shifted from the m/z 200 plane to that of m/z 2000, the FWHM at the same plane position had expanded 1.5 ns, which would greatly compromise resolution on most systems.

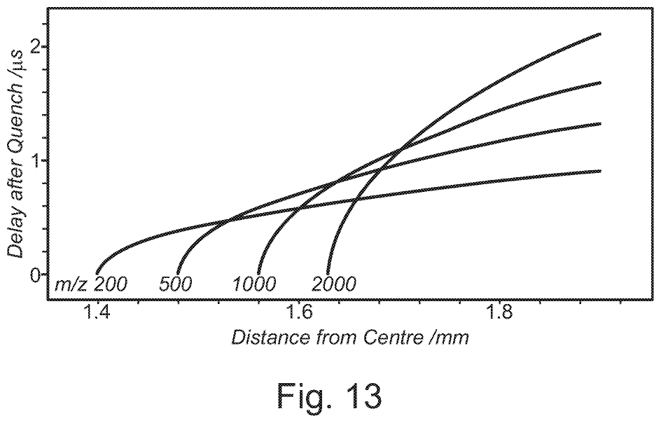

FIG. 13 demonstrates one aspect of the present disclosure, whereby the extraction pulse is delayed after an RF quench so that ion planes move only under a low repulsive field provided by the grid electrode. This has the effect of focusing ions and reducing the spread in the ions' average positions in the z-direction. It can be observed that the optimum occurs when the lowest mass matches the position of the high mass, about 0.5 μs for the 200-2000 mass range under 10V of applied DC, which shrinks the positional deviation from 0.23 to 0.07 mm. It may also be advantageous to vary the DC field during the delay period, or add additional delays and steps prior to extraction. Controlling the phase of the RF quench instead of using the electronically simplest 0 point may also have uses for manipulation of ion phase space, such as described in U.S. Pat. No. 10,734,210B2.

The foregoing figures illustrate that delayed extraction of ions can be advantageous. As mentioned previously, a disadvantage of known RF carpets is that because the trapped ion plane is located at the point in which the pseudopotential is strong enough to balance the counterforce from the DC, ions of different m/z settle at different distances from the RF surface. For a time-of-flight analyser this is problematic, as m/z shifts can be introduced. Certain embodiments of the present disclosure address this issue, as demonstrated by these simulation results. Accordingly, in a generalised aspect, there is provided an apparatus for trapping ions, in which a control circuit is configured to: cease application of (i.e. turn off, or at least reduce to a negligible percentage of its original value, such as less than 10% or less than 1%) the set of oscillatory voltages to the array of electrodes during a delay period; apply a focusing voltage to at least one of the one or more further electrodes, during the delay period, to force the ions towards the array of electrodes; and apply an extraction voltage to at least one of the array of electrodes and/or the one or more further electrodes, after the delay period, to extract the ions from the trapping region. Applying the extraction voltage after expiry of a delay period can ensure that ions are focused within a narrow range of spatial positions, which can give a more consistent trapping position and thereby reduce the m/z shifts introduced by known RF carpets when coupled to ToF analysers. Ceasing application of the set of oscillatory voltages may occur after the ions have been trapped within the trapping region.

Continuing to use the generalised terms used previously, the control circuits of the present disclosure may be configured to apply the focusing voltage and the trapping voltage to the same at least one electrode (e.g. upper electrode 102 and/or 108) of the one or more further electrodes. For instance, the focusing voltage may be the trapping voltage. That is, during the delay period, the trapping voltage may continue to be applied and the continued application of the trapping voltage may have a focusing effect on the ions in the trapping region. The ions may therefore be focused (i.e. occupy a narrower range of heights (z-values)) due to the application of the trapping voltage during the delay period and so the trapping voltage may act as a focusing voltage after the set of oscillatory voltages ceases being applied to the array of electrodes. The electrode to which the focusing and/or trapping voltages are applied may be on an upper surface (also described herein as a second surface) of the apparatus for trapping ions, i.e. said electrode may oppose the array of electrodes (RF carpet).

In some embodiments, the focusing voltage may have a smaller magnitude than a magnitude (e.g. a peak magnitude, or an RMS magnitude) of the set of oscillatory voltages. For example, the focusing voltage may have a magnitude of at least 5V, at least 10V, or at least 20V. The focusing voltage is preferably a DC voltage. The focusing voltage may increase in magnitude for at least a portion of the delay period, which may allow for a shorter delay period, which may help reduce ion dispersion.

The focusing voltage does not necessarily need to be the same as the trapping voltage. For example, the trapping voltage may also be ceased when the set of oscillatory voltages ceases to be applied, and a different focusing voltage may be applied during the delay period. The precise nature of the focusing voltage can vary depending on the particular sample that is being trapped. In some embodiments, the magnitude of the focusing voltage may be ramped or pulsed during the delay period. The focusing voltage may have a plurality of different magnitudes during a plurality of respective time intervals (e.g. sub-intervals of the delay period) during the delay period. The focusing voltage may be constant (e.g. have a constant magnitude) in some time intervals during the delay period (e.g. constant for all of the delay period, or constant in certain sub-intervals of the delay period) and linearly or non-linearly varying during other time intervals in the delay period. Accordingly, the range of distances (heights in the z-direction) at which ions are positioned can be fine-tuned prior to extraction. This can be used to optimise the shape of the ion cloud to ensure that the ion cloud is suitable for subsequent analysis (for example by a mass analyser).

Hence, it can be seen that numerous advantages can be achieved using aspects and embodiments of the present disclosure. For example, delayed extraction can be used to pre-focus ions of different m/z, for matching focal planes. Moreover, gradual slow step-up or ramp of the trapping voltage after ion injection can be used to limit pick up of energy by ions and compress them onto the RF carpet. This can reduce the risk of loss of ions due to collisions with an RF carpet. Moreover, trapping around the plane of the RF carpet via DC electrodes on a top plate can provide improved manipulation of ions. The provision of a dual-pressure RF carpet extraction trap, which can be built on a PCB top-plate with a gas restrictor, also contributes to improved processing of ions. The dual-pressure trap is simpler to manufacture and operate than known multipole-based systems and facilitates low-energy transfer of ions across pressure regions 106A, 106B with very narrow apertures.

The trap concepts described above benefit from being extremely mechanically simple and less electronically complex than existing systems, for example because there is no need to superimpose HV pulses on RF electrodes (such as electrodes 101+, 101−) like with equivalent trapping systems. Functionally, the systems described herein can provide more planar ion clouds that are optimal for space charge performance in time-of-flight mass analysers. Using PCB plates, for example, with segmented printed electrodes, and resistor chains to provide voltage gradients provides a simple means for implementing the aspects and embodiments described above.

In this disclosure, RF voltages have been described extensively, for example when referring to the RF carpet (array of electrodes to which RF oscillatory voltages may be applied). It will be appreciated that RF may mean from 20 kHz up to 300 GHz.

Moreover, voltages are described extensively herein and it will be appreciated that all voltages are relative to ground (or some other appropriate reference point). Thus, high voltages are to be interpreted as meaning a relatively high potential difference with respect to the reference point when compared with the potential differences between other elements and the reference point.

It will be understood that many variations may be made to the above apparatus, systems and methods whilst retaining the advantages noted previously. For example, where specific components have been described, alternative components can be provided that provide the same or similar functionality.

Embodiments have been described as being provided on one or more substrates. For example, the electrodes described herein (e.g. the array of electrodes and other electrodes) may be on one or more substates. Such substrates may be printed circuit boards, PCBs, or other structures for mechanically supporting electrodes may be used. PCBs provide a particularly cost-effective and easy-to-manufacture substrate. However, the trap constructions described herein need not be built onto a substrate 103 as shown, but electrodes may be supported elsewhere, such as on terminal rods with the electrodes separated via spacers.

The counter-electrodes 102 described herein may be entirely gridded, provided by a metal plate or PCB incorporating a grid, or may even be a gridless aperture for more narrow sizes. Lateral focusing may be incorporated to help squeeze ions through such an aperture during extraction. The RF electrodes 101+, 101− may be printed on PCB, solid machined electrodes or even very small electrodes made by MEMS and lithographic methods.

The extraction trap may be compatible with linear, single and multi-reflection, and sector-based ToF analysers. Any mass analyser can be coupled to the devices described herein. The traps described herein may also be combined with Fourier transform analysers such as orbital trapping mass analysers. The trap may be feasibly combined with MALDI or desorption-based ion sources.

The dual-pressure traps described herein may be entirely enclosed excepting the extraction grid 102 and entrance aperture 110 or may be separately pumped. The main cooling cell may be operated as a collision region.

The delayed extraction method described herein may involve additional stages or voltage pulses.

The rise time of the extraction pulse may be controlled to correct for the mass dependent energy variation induced by the differing ion start positions (slow rise time causes low m/z ions to emerge with lower energy relative to high m/z). This may further help promote mass independent behaviour in conjunction with delayed extraction.

In some embodiments, a repulsive pulse may be applied to the array of electrodes (at hundreds to low thousands of volts) to eject ions. This can require complex electronics, so preferred embodiments use an extraction grid. However, an advantage of using the array to eject ions is that it is possible to apply extraction voltages of opposing polarity to both the extraction electrode and to the array, and thereby double the field strength.

Moreover, in some aspects and embodiments, oscillatory (AC) voltage(s) (perhaps with a DC bias towards the carpet) may be applied to the extraction grid (also known as a trapping electrode) to trap the ions against the array. Hence, an AC counter electrode (or counter electrode set) may be provided. Two different AC pseudopotentials may balance the ion position, without creating axial well artifacts. In some embodiments, an AC set of voltages might be superimposed onto the DC electrode, similar to the RF surface, which may be used to create an additional repulsion were ions to get close to the DC electrode.

Each feature disclosed in this specification, unless stated otherwise, may be replaced by alternative features serving the same, equivalent or similar purpose. Thus, unless stated otherwise, each feature disclosed is one example only of a generic series of equivalent or similar features.

As used herein, including in the claims, unless the context indicates otherwise, singular forms of the terms herein are to be construed as including the plural form and, where the context allows, vice versa. For instance, unless the context indicates otherwise, a singular reference herein including in the claims, such as “a” or “an” (such as an electrode detector or a voltage) means “one or more” (for instance, one or more electrodes, or one or more voltages). Throughout the description and claims of this disclosure, the words “comprise”, “including”, “having” and “contain” and variations of the words, for example “comprising” and “comprises” or similar, mean that the described feature includes the additional features that follow, and are not intended to (and do not) exclude the presence of other components.

The use of any and all examples, or exemplary language (“for instance”, “such as”, “for example” and like language) provided herein, is intended merely to better illustrate the disclosure and does not indicate a limitation on the scope of the disclosure unless otherwise claimed. No language in the specification should be construed as indicating any non-claimed element as essential to the practice of the disclosure.

Any steps described in this specification may be performed in any order or simultaneously unless stated or the context requires otherwise. Moreover, where a step is described as being performed after a step, this does not preclude intervening steps being performed.

All of the aspects and/or features disclosed in this specification may be combined in any combination, except combinations where at least some of such features and/or steps are mutually exclusive. In particular, the preferred features of the disclosure are applicable to all aspects and embodiments of the disclosure and may be used in any combination. Likewise, features described in non-essential combinations may be used separately (not in combination).

Moreover, although aspects and embodiments have primarily been described with reference to physical apparatus, the disclosure also provides methods of manufacturing and using such apparatus. For example, methods of manufacturing any of the apparatus described herein are provided, as are methods of using the apparatus described herein.

### CLAUSES

1. An apparatus for trapping ions, comprising:
   an array of electrodes, the array extending along a surface of the apparatus;
   one or more further electrodes that are distinct from the array of electrodes;
   a trapping region for receiving the ions, defined by the array of electrodes and the one or more further electrodes; and
   a control circuit configured to:
      apply a set of oscillatory voltages to the array of electrodes to repel the ions from the array of electrodes, each electrode in the array of electrodes having a different phase to each adjacent electrode;
      apply a trapping voltage to at least one of the one or more further electrodes to force the ions towards the array of electrodes, the set of oscillatory voltages and the trapping voltage thereby trapping the ions within the trapping region;
      cease application of the set of oscillatory voltages to the array of electrodes during a delay period;
      apply a focusing voltage to at least one of the one or more further electrodes, during the delay period, to force the ions towards the array of electrodes; and
      apply an extraction voltage to at least one of the array of electrodes and/or the one or more further electrodes, after the delay period, to extract the ions from the trapping region.
2. The apparatus of clause 1, wherein the control circuit is configured to apply the focusing voltage and the trapping voltage to the same at least one electrode of the one or more further electrodes.
3. The apparatus of clause 1 or clause 2, wherein the focusing voltage is the trapping voltage.
4. The apparatus of any preceding clause, wherein the focusing voltage has a smaller magnitude than a magnitude of the set of oscillatory voltages.
5. The apparatus of any preceding clause, wherein the focusing voltage has a magnitude of at least 5V, at least 10V, or at least 20V.
6. The apparatus of any preceding clause, wherein the focusing voltage is a direct current, DC, voltage.
7. The apparatus of any preceding clause, wherein the delay period has a duration of:
   from 0.1 μs to 2 μs; or
   from 0.1 μs to 1 μs.
8. The apparatus of any preceding clause, wherein the control circuit is configured to:
   apply the set of oscillatory voltages and the trapping voltage such that the ions are positioned at a first range of distances from the array of electrodes; and
   apply the focusing voltage so as to reduce the first range of distances from the array of electrodes at which the ions are positioned.
9. The apparatus of any preceding clause, wherein the magnitude of the focusing voltage is ramped or pulsed during the delay period.
10. The apparatus of any preceding clause, wherein the focusing voltage has a plurality of different magnitudes during a plurality of respective time intervals during the delay period.
11. The apparatus of any preceding clause, wherein the magnitude of the focusing voltage is constant during the delay period.
12. An apparatus for trapping ions, comprising:
   an array of electrodes, the array extending along a surface of the apparatus;
   one or more further electrodes that are distinct from the array of electrodes;
   a trapping region for receiving the ions, defined by the array of electrodes and the one or more further electrodes; and
   a control circuit configured to:
      apply a set of oscillatory voltages to the array of electrodes to repel the ions from the array of electrodes, each electrode in the array of electrodes having a different phase to each adjacent electrode; and
      apply a trapping voltage to at least one of the one or more further electrodes to force the ions towards the array of electrodes, the set of oscillatory voltages and the trapping voltage thereby trapping the ions within the trapping region, wherein the trapping voltage is a time-varying direct current, DC, voltage that increases in magnitude over time.
13. The apparatus of clause 12, wherein the trapping voltage has a relatively low magnitude while ions are injected into the trapping region and increases in magnitude after the ions are injected into the trapping region.
14. The apparatus of clause 12 or clause 13, wherein the magnitude of the trapping voltage while ions are injected into the trapping region is less than 5V, less than 3V, less than 2V, or less than 1.5V.
15. The apparatus of any of clauses 12 to 14, wherein the trapping voltage increases in magnitude over time until reaching a maximum voltage.
16. The apparatus of clause 15, wherein the magnitude of the trapping voltage is constant after reaching the maximum voltage.
17. The apparatus of any of clauses 12 to 16, wherein the magnitude of the trapping voltage increases to a maximum voltage of at least 5V, at least 10V, or at least 20V.
18. The apparatus of any of clauses 12 to 17, wherein the trapping voltage reaches a maximum voltage after at least 1 ms, at least 2 ms, or at least 3 ms.
19. The apparatus of any of clauses 12 to 18, wherein the magnitude of the trapping voltage continuously increases over time.
20. The apparatus of any of clauses 12 to 19, wherein the magnitude of the trapping voltage linearly increases over time.
21. The apparatus of any of clauses 12 to 20, wherein the magnitude of the trapping voltage increases at a rate of at least 1×10³ Vs⁻¹, at least 2×10³ Vs⁻¹, or at least 5×10³ Vs⁻¹.
22. An apparatus for trapping ions, comprising:
   an array of electrodes, the array extending along a surface of the apparatus;
   one or more further electrodes that are distinct from the array of electrodes;
   a trapping region for receiving the ions, defined by the array of electrodes and the one or more further electrodes, the trapping region having a relatively low-pressure region and a relatively high-pressure region; and
   a control circuit configured to:
      apply a set of oscillatory voltages to the array of electrodes to repel the ions from the array of electrodes, each electrode in the array of electrodes having a different phase to each adjacent electrode; and
      apply a trapping voltage to at least one of the one or more further electrodes to force the ions towards the array of electrodes, the set of oscillatory voltages and the trapping voltage thereby trapping the ions within the trapping region.
23. The apparatus of clause 22, wherein the array of electrodes extends along the relatively low-pressure region of the trapping region and along the relatively high-pressure region of the trapping region.
24. The apparatus of clause 22 or clause 23, further comprising a gas restrictor between the relatively low-pressure region and the relatively high-pressure region.
25. The apparatus of clause 24, wherein the control circuit is configured to apply a voltage to the gas restrictor to:
   trap ions in the relatively high-pressure region;
   transport ions to the relatively low-pressure region; and/or
   match an electric field strength in the relatively high-pressure region and/or the relatively low-pressure region.
26. The apparatus of clause 24 or clause 25, wherein the voltage applied to the gas restrictor is a DC voltage.
27. The apparatus of any of clauses 24 to 26, further comprising a second surface, the second surface opposing the array of electrodes, wherein the gas restrictor extends from the second surface and towards the array of electrodes.
28. The apparatus of any of clauses 24 to 27, wherein at least one electrode of the array of electrodes near the gas restrictor is narrower than a plurality of other electrodes of the array of electrodes.
29. The apparatus of any of clauses 22 to 28, wherein:
   the relatively high-pressure region has a pressure of from 0.1 to 2×10⁻² mbar; and/or
   the relatively low-pressure region has a pressure of from 0.5 to 5×10⁻³ mbar.
30. The apparatus of any preceding clause, wherein at least one of the array of electrodes and the one or more further electrodes is a transport electrode and wherein the control circuit is configured to apply a transport voltage to the transport electrode to transport ions along the trapping region.
31. The apparatus of clause 31, wherein the trapping region has a relatively low-pressure region and a relatively high-pressure region, wherein the control circuit is configured to apply the transport voltage to transport ions between the relatively high-pressure region of the trapping region and the relatively low-pressure region of the trapping region.
32. The apparatus of clause 30 or clause 31, wherein the transport voltage has a DC gradient configured to transport ions along the DC gradient.
33. The apparatus of any of clauses 30 to 32, wherein the transport voltage is a DC voltage.
34. The apparatus of any of clauses 30 to 32, wherein the transport voltage comprises a travelling wave configured to transport ions in a direction of the travelling wave.
35. The apparatus of clause 34, wherein the control circuit is configured to superimpose the travelling wave voltage onto the set of oscillatory voltages applied to the array of electrodes.
36. The apparatus of any of clauses 30 to 35, wherein the control circuit is configured to apply the transport voltage to the array of electrodes.
37. The apparatus of any of clauses 30 to 36, wherein the transport electrode comprises a plurality of transport electrode segments, wherein the control circuit is configured to apply a voltage gradient across the plurality of transport electrode segments.
38. The apparatus of any of clauses 30 to 37, wherein the one or more further electrodes comprise the transport electrode and wherein the transport electrode is a funnelling electrode, wherein the control circuit is configured to apply the transport voltage to the funnelling electrode.
39. The apparatus of clause 38, wherein the control circuit is configured to apply the transport voltage to the funnelling electrode to funnel ions as the ions move along the trapping region.
40. The apparatus of clause 39, wherein the control circuit is configured to apply the transport voltage to reduce a lateral separation of the ions as the ions move along the trapping region.
41. The apparatus of clause 39 or clause 40, further comprising an ion inlet for allowing ions to enter the trapping region, wherein the funnelling electrode comprises a first portion and a second portion, wherein the first portion of the funnelling electrode is tapered away from the ion inlet.
42. The apparatus of clause 41, wherein the first and second portions of the funnelling electrode are substantially coplanar.
43. The apparatus of clause 41 or clause 42, wherein the control circuit is configured to apply a higher voltage to the second portion of the funnelling electrode than to the first portion of the funnelling electrode.
44. The apparatus of any preceding clause, wherein the control circuit is configured to apply the trapping voltage to the one or more further electrodes after the ions have entered the trapping region.
45. The apparatus of clause 44, wherein the trapping voltage has a magnitude that is smaller than a magnitude of the set of oscillatory voltages applied to the array of electrodes.
46. The apparatus of clause 44 or clause 45, wherein the trapping voltage is a DC voltage.
47. The apparatus of any preceding clause, wherein at least one of the array of electrodes and the one or more further electrodes comprises an extraction electrode and the control circuit is configured to apply the extraction voltage to the extraction electrode.
48. The apparatus of clause 47, wherein the extraction electrode is opposite the array of electrodes, preferably wherein the extraction electrode is substantially parallel with the array of electrodes.
49. The apparatus of clause 47 or clause 48, wherein the extraction electrode comprises one or more apertures for allowing ions to pass therethrough.
50. The apparatus of any of clauses 47 to 49, wherein the extraction electrode is a gridded electrode and/or a segmented electrode comprising a plurality of apertures for allowing ions to pass therethrough.
51. The apparatus of any of clauses 47 to 50, wherein the extraction voltage has a greater magnitude than a magnitude of the trapping voltage.
52. The apparatus of any of clauses 47 to 51, wherein the control circuit is configured to apply:
   the trapping voltage to the extraction electrode to trap ions within the trapping region; and
   the extraction voltage to the extraction electrode to extract the ions from the trapping region.
53. The apparatus of any of clauses 47 to 52, wherein the trapping region has a relatively low-pressure region and a relatively high-pressure region and wherein the extraction electrode extends along the relatively low-pressure region.
54. The apparatus of any preceding clause, comprising a second surface, the second surface opposing the array of electrodes, wherein the second surface comprises any one or more of: an extraction electrode; a transport electrode; and/or a funnelling electrode.
55. The apparatus of any preceding clause, wherein the array of electrodes has a spacing of: less than 5 mm; less than 3 mm; less than 1 mm; less than 0.1 mm; or less than 0.01 mm.
56. The apparatus of any preceding clause, wherein each electrode in the array of electrodes has an opposite phase to each adjacent electrode.
57. The apparatus of any preceding clause, wherein the array of electrodes is substantially planar.
58. The apparatus of any preceding clause, wherein the one or more further electrodes comprise one or more barrier electrodes positioned around a perimeter of the trapping region, and the control circuit is configured to apply a barrier voltage to the one or more barrier electrodes to trap the ions within the trapping region.
59. The apparatus of clause 58, wherein:
   the control circuit is configured to apply the set of oscillatory voltages and the trapping voltage such that the ions are positioned at a first range of distances from the array of electrodes; and
   the barrier voltage defines a potential barrier that extends to at least the first range of distances from the array of electrodes.
60. The apparatus of clause 58 or clause 59, wherein control circuit is configured to apply any one or more of:
   a DC barrier voltage to at least one of the one or more barrier electrodes;
   a radio frequency, RF, barrier voltage to at least one of the one or more barrier electrodes; and/or
   a superposition of a DC barrier voltage and an RF barrier voltage to at least one of the one or more barrier electrodes.
61. The apparatus of any of clauses 58 to 60, wherein the one or more barrier electrodes comprise a plurality of barrier electrodes.
62. The apparatus of clause 61, wherein the control circuit is configured to apply barrier voltages having opposite phases to adjacent barrier electrodes.
63. The apparatus of clause 61 or clause 62, wherein one or more of the plurality of barrier electrodes are positioned at an end of an electrode of the array of electrodes.
64. The apparatus of any preceding clause, further comprising one or more substrates, wherein at least one of the one or more further electrodes and the array of electrodes are on the one or more substates.
65. The apparatus of clause 64, wherein the one or more substrates are one or more printed circuit boards, PCBs.
66. A mass spectrometry system comprising:
   an apparatus for trapping ions according to any of the preceding clauses; and
   a mass analyser configured to receive ions from the apparatus for trapping ions, preferably wherein the mass analyser is a time-of-flight mass analyser.

1. An apparatus for trapping ions, comprising:
an array of electrodes, the electrodes of the array extending along a surface of the apparatus;
one or more further electrodes that are distinct from the array of electrodes;
a trapping region for receiving the ions, defined by the array of electrodes and the one or more further electrodes; and
a control circuit configured to:
apply a set of oscillatory voltages to the array of electrodes to repel the ions from the array of electrodes, each electrode in the array of electrodes having a different phase to each adjacent electrode;
apply a trapping voltage to at least one of the one or more further electrodes to force the ions towards the array of electrodes, the set of oscillatory voltages and the trapping voltage thereby trapping the ions within the trapping region;
cease application of the set of oscillatory voltages to the array of electrodes during a delay period;
apply a focusing voltage to at least one of the one or more further electrodes, during the delay period, to force the ions towards the array of electrodes; and
apply an extraction voltage to at least one of the array of electrodes and/or the one or more further electrodes, after the delay period, to extract the ions from the trapping region.

2. The apparatus of claim 1, wherein the control circuit is configured to apply the focusing voltage and the trapping voltage to the same at least one electrode of the one or more further electrodes.

3. The apparatus of claim 1 or claim 2, wherein the focusing voltage is the trapping voltage.

4. The apparatus of any preceding claim, wherein the focusing voltage has:
a smaller magnitude than a magnitude of the set of oscillatory voltages; and/or
a magnitude of at least 5V, at least 10V, or at least 20V.

5. The apparatus of any preceding claim, wherein the focusing voltage is a direct current, DC, voltage.

6. The apparatus of any preceding claim, wherein the delay period has a duration of:
from 0.1 μs to 2 μs; or
from 0.1 μs to 1 μs.

7. The apparatus of any preceding claim, wherein the control circuit is configured to:
apply the set of oscillatory voltages and the trapping voltage such that the ions are positioned at a first range of distances from the array of electrodes; and
apply the focusing voltage so as to reduce the first range of distances from the array of electrodes at which the ions are positioned.

8. The apparatus of any preceding claim, wherein the magnitude of the focusing voltage is ramped or pulsed during the delay period.

9. The apparatus of any preceding claim, wherein the focusing voltage has a plurality of different magnitudes during a plurality of respective time intervals during the delay period.

10. The apparatus of any preceding claim, wherein the magnitude of the focusing voltage is constant during the delay period.

11. An apparatus for trapping ions, comprising:
an array of electrodes, the electrodes of the array extending along a surface of the apparatus;
one or more further electrodes that are distinct from the array of electrodes;
a trapping region for receiving the ions, defined by the array of electrodes and the one or more further electrodes; and
a control circuit configured to:
apply a set of oscillatory voltages to the array of electrodes to repel the ions from the array of electrodes, each electrode in the array of electrodes having a different phase to each adjacent electrode; and
apply a trapping voltage to at least one of the one or more further electrodes to force the ions towards the array of electrodes, the set of oscillatory voltages and the trapping voltage thereby trapping the ions within the trapping region, wherein the trapping voltage is a time-varying direct current, DC, voltage that increases in magnitude over time.

12. The apparatus of claim 11, wherein the trapping voltage has a relatively low magnitude while ions are injected into the trapping region and increases in magnitude after the ions are injected into the trapping region.

13. The apparatus of claim 11 or claim 12, wherein the magnitude of the trapping voltage while ions are injected into the trapping region is less than 5V, less than 3V, less than 2V, or less than 1.5V.

14. The apparatus of any of claims 11 to 13, wherein the trapping voltage increases in magnitude over time until reaching a maximum voltage, preferably wherein the magnitude of the trapping voltage is constant after reaching the maximum voltage.

15. The apparatus of any of claims 11 to 14, wherein the magnitude of the trapping voltage increases to a maximum voltage of at least 5V, at least 10V, or at least 20V.

16. The apparatus of any of claims 11 to 15, wherein the trapping voltage reaches a maximum voltage after at least 1 ms, at least 2 ms, or at least 3 ms.

17. The apparatus of any of claims 11 to 16, wherein:
the magnitude of the trapping voltage continuously increases over time; and/or
the magnitude of the trapping voltage linearly increases over time.

18. The apparatus of any of claims 11 to 17, wherein the magnitude of the trapping voltage increases at a rate of at least 1×10³ Vs⁻¹, at least 2×10³ Vs⁻¹, or at least 5×10³ Vs⁻¹.

19. An apparatus for trapping ions, comprising:
an array of electrodes, the electrodes of the array extending along a surface of the apparatus;
one or more further electrodes that are distinct from the array of electrodes;
a trapping region for receiving the ions, defined by the array of electrodes and the one or more further electrodes, the trapping region having a relatively low-pressure region and a relatively high-pressure region; and
a control circuit configured to:
apply a set of oscillatory voltages to the array of electrodes to repel the ions from the array of electrodes, each electrode in the array of electrodes having a different phase to each adjacent electrode; and
apply a trapping voltage to at least one of the one or more further electrodes to force the ions towards the array of electrodes, the set of oscillatory voltages and the trapping voltage thereby trapping the ions within the trapping region.

20. The apparatus of claim 19, wherein the array of electrodes extends along the relatively low-pressure region of the trapping region and along the relatively high-pressure region of the trapping region.

21. The apparatus of claim 19 or claim 20, further comprising a gas restrictor between the relatively low-pressure region and the relatively high-pressure region.

22. The apparatus of claim 21, wherein the control circuit is configured to apply a voltage, preferably a DC voltage, to the gas restrictor to:
trap ions in the relatively high-pressure region;
transport ions to the relatively low-pressure region; and/or
match an electric field strength in the relatively high-pressure region and/or the relatively low-pressure region.

23. The apparatus of any of claims 21 to 22, further comprising a second surface, the second surface opposing the array of electrodes, wherein the gas restrictor extends from the second surface and towards the array of electrodes.

24. The apparatus of any of claims 21 to 23, wherein at least one electrode of the array of electrodes near the gas restrictor is narrower than a plurality of other electrodes of the array of electrodes.

25. The apparatus of any of claims 21 to 24, wherein:
the relatively high-pressure region has a pressure of from 0.1 to 2×10⁻² mbar; and/or
the relatively low-pressure region has a pressure of from 0.5 to 5×10⁻³ mbar.

26. The apparatus of any preceding claim, wherein at least one of the array of electrodes and the one or more further electrodes is a transport electrode and wherein the control circuit is configured to apply a transport voltage to the transport electrode to transport ions along the trapping region.

27. The apparatus of claim 26, wherein the trapping region has a relatively low-pressure region and a relatively high-pressure region, wherein the control circuit is configured to apply the transport voltage to transport ions between the relatively high-pressure region of the trapping region and the relatively low-pressure region of the trapping region.

28. The apparatus of any of claims 26 to 27, wherein the one or more further electrodes comprise the transport electrode and wherein the transport electrode is a funnelling electrode, wherein the control circuit is configured to apply the transport voltage to the funnelling electrode.

29. The apparatus of claim 28, wherein the control circuit is configured to apply the transport voltage to the funnelling electrode to funnel ions as the ions move along the trapping region.

30. The apparatus of any preceding claim, wherein the control circuit is configured to apply the trapping voltage to the one or more further electrodes after the ions have entered the trapping region.

31. The apparatus of claim 30, wherein the trapping voltage has a magnitude that is smaller than a magnitude of the set of oscillatory voltages applied to the array of electrodes.

32. The apparatus of claim 30 or claim 31, wherein the trapping voltage is a DC voltage.

33. The apparatus of any preceding claim, wherein at least one of the array of electrodes and the one or more further electrodes comprises an extraction electrode and the control circuit is configured to apply the extraction voltage to the extraction electrode.

34. The apparatus of claim 33, wherein the extraction voltage has a greater magnitude than a magnitude of the trapping voltage.

35. The apparatus of any of claims 33 to 34, wherein the control circuit is configured to apply:
the trapping voltage to the extraction electrode to trap ions within the trapping region; and
the extraction voltage to the extraction electrode to extract the ions from the trapping region.

36. The apparatus of any of claims 33 to 35, wherein the trapping region has a relatively low-pressure region and a relatively high-pressure region and wherein the extraction electrode extends along the relatively low-pressure region.

37. The apparatus of any preceding claim, wherein the one or more further electrodes comprise one or more barrier electrodes positioned around a perimeter of the trapping region, and the control circuit is configured to apply a barrier voltage to the one or more barrier electrodes to trap the ions within the trapping region.

38. The apparatus of claim 37, wherein:
the control circuit is configured to apply the set of oscillatory voltages and the trapping voltage such that the ions are positioned at a first range of distances from the array of electrodes; and
the barrier voltage defines a potential barrier that extends to at least the first range of distances from the array of electrodes.

39. A mass spectrometry system comprising:
an apparatus for trapping ions according to any of the preceding claims; and
a mass analyser configured to receive ions from the apparatus for trapping ions, preferably wherein the mass analyser is a time-of-flight mass analyser.
